(19) United States
(12) Patent Application Publication
(10) Pub. No.: US 2004/0021387 A1
(43) Pub. Date: Feb. 5, 2004

(54) Homopolar generator

(76) Inventor: Eric James Whitesell, Carlsbad, CA (US)

Correspondence Address: Eric James Whitesell, 3537 Coastview Ct, Carlsbad, CA, 92008, US

(21) Appl. No.: 10/210,213

(22) Filed: Aug. 1, 2002

(51) Int. Cl. H02K 17/42

(52) U.S. Cl. 310/168

(57) ABSTRACT

A homopolar generator includes a plurality of rotor elements arranged adjacent to one another on a single circumference of a circle around an axis of rotation for generating an electric current in at least one of the plurality of rotor elements when the plurality of rotor elements is rotated about the axis of rotation in a magnetic field that extends radially through the plurality of rotor elements relative to the axis of rotation. A first brush ring encircles the axis of rotation and is coupled to the at least one of the plurality of rotor elements. A second brush ring encircles the axis of rotation and is coupled to the at least one of the plurality of rotor elements wherein the second brush ring maintains continuous electrical contact with the first brush ring through the at least one of the plurality of rotor elements for all angles of rotation of the at least one of the plurality of rotor elements about the axis of rotation.

### BACKGROUND OF THE INVENTION

The present invention relates generally to homopolar machines. More specifically, but without limitation thereto, the present invention relates to a homopolar generator comprising multiple rotor elements.

### SUMMARY OF THE INVENTION

In one aspect of the present invention, a homopolar generator provides a voltage output that is suitable for many direct current devices and may also be converted by readily available inverters to various frequencies and voltages to suit a wide variety of applications.

In one embodiment of the present invention, a homopolar generator includes a plurality of rotor elements arranged adjacent to one another on a single circumference of a circle around an axis of rotation to generate an electric current when the plurality of rotor elements is rotated about the axis of rotation in a magnetic field that extends radially through the plurality of rotor elements relative to the axis of rotation. A first brush ring and a second brush ring are coupled to at least one of the plurality of rotor elements to conduct the electric current through the at least one of the plurality of rotor elements between the first brush ring and the second brush ring continuously for all angles of rotation of the at least one of the plurality of rotor elements about the axis of rotation.

In a further embodiment, the at least one of the plurality of rotor elements includes an inner surface that extends lengthwise along the at least one of the plurality of rotor elements and faces the axis of rotation, an outer surface that extends lengthwise along the at least one of the plurality of rotor elements and faces away from the axis of rotation, a first side that terminates the inner surface and the outer surface lengthwise along the at least one of the plurality of rotor elements, and a second side opposite the first side that terminates the inner surface and the outer surface lengthwise along the at least one of the plurality of rotor elements.

In a further embodiment, the homopolar generator includes a source of the magnetic field coupled to the plurality of rotor elements.

In a further embodiment, the source of the magnetic field is coupled to rotate with the plurality of rotor elements about the axis of rotation.

In a further embodiment, the homopolar generator includes a flux return coupled to the source of the magnetic field for returning the magnetic field outside the plurality of rotor elements from the inner surface to the outer surface of the at least one of the plurality of rotor elements.

In a further embodiment, a first load brush makes sliding electrical contact with the first brush ring and a second load brush makes sliding electrical contact, with the second brush ring to couple the electric current to an electrical load.

In a further embodiment, a load brush support extends between the flux return and the plurality of rotor elements to support the first load brush and the second load brush.

In another embodiment of the present invention, a homopolar generator includes a plurality of rotor elements arranged adjacent to one another on a single circumference of a circle around an axis of rotation to generate a voltage across a middle portion of at least one of the plurality of rotor elements between a proximal portion and a distal portion of the at least one of the plurality of rotor elements when the plurality of rotor elements is rotated about the axis of rotation in a magnetic field that extends radially through the plurality of rotor elements relative to the axis of rotation. The middle portion of the at least one of the plurality of rotor elements includes an inner surface that extends lengthwise along the middle portion and faces the axis of rotation, an outer surface that extends lengthwise along the middle portion and faces away from the axis of rotation, a first side that terminates the inner surface and the outer surface lengthwise along the middle portion, and a second side opposite the first side that terminates the inner surface and the outer surface lengthwise along the middle portion. A first brush ring encircles the axis of rotation and is coupled to the proximal portion of the at least one of the plurality of rotor elements, and a second brush ring encircles the axis of rotation and is coupled to the distal portion of the at least one of the plurality of rotor elements. The first brush ring and the second brush ring are coupled to the at least one of the plurality of rotor elements to maintain continuous electrical contact through the at least one of the plurality of rotor elements between the first brush ring and the second brush ring for all angles of rotation of the at least one of the plurality of rotor elements about the axis of rotation.

In still another embodiment of the present invention, a homopolar generator includes a plurality of rotor elements arranged adjacent to one another on a single circumference of a circle around an axis of rotation to generate an electric current when the plurality of rotor elements is rotated about the axis of rotation in a magnetic field that extends radially through the plurality of rotor elements relative to the axis of rotation. A first brush ring and a second brush ring encircle the axis of rotation and are coupled to at least one of the plurality of rotor elements to maintain continuous electrical contact through the at least one of the plurality of rotor elements between the first brush ring and the second brush ring for all angles of rotation of the at least one of the plurality of rotor elements about the axis of rotation. The at least one of the plurality of rotor elements includes an inner surface extending lengthwise along the at least one of the plurality of rotor elements and facing the axis of rotation, an outer surface extending lengthwise along the at least one of the plurality of rotor elements and facing away from the axis of rotation, a first side that terminates the inner surface and the outer surface lengthwise along the at least one of the plurality of rotor elements, and a second side opposite the first side that terminates the inner surface and the outer surface lengthwise along the at least one of the plurality of rotor elements.

In a further embodiment, a first load brush makes sliding electrical contact with the first brush ring and a second load brush makes sliding electrical contact with the second brush ring for coupling the electric current to an electrical load.

In a further embodiment, the homopolar generator includes the electrical load.

In a further embodiment, the homopolar generator includes a source of the magnetic field coupled to the plurality of rotor elements.

In a further embodiment, the source of the magnetic field includes at least one of a permanent magnet and an electromagnet.

In other embodiments, the source of the magnetic field may also be coupled to the plurality of rotor elements to rotate with the plurality of rotor elements about the axis of rotation, and the source of the magnetic field may include a flux return for returning the magnetic field outside the plurality of rotor elements from the inner surface to the outer surface of the middle portion of the at least one of the plurality of rotor elements.

### DESCRIPTION OF THE SEVERAL VIEWS OF THE DRAWINGS

The present invention is illustrated by way of example and not limitation in the accompanying figures, in which like references indicate similar elements throughout the several views of the drawings, and in which:

FIG. 1 illustrates a simplified diagram of a homopolar generator according to an embodiment of the present invention;

FIG. 2 illustrates a cross-sectional view of a brush ring according to an embodiment of the present invention;

FIG. 3 illustrates a front view of the embodiment illustrated in FIG. 2;

FIG. 4 illustrates a cross-sectional view of a source of a magnetic field for the homopolar generator of FIG. 1 according to an embodiment of the present invention;

FIG. 5 illustrates a cross-sectional view of a homopolar generator including a flux return according to an embodiment of the present invention; and

FIG. 6 illustrates an annular part of a brush support for the homopolar generator of FIG. 5.

Elements in the figures are illustrated for simplicity and clarity and have not necessarily been drawn to scale. For example, the dimensions of some of the elements in the figures may be exaggerated relative to other elements, and certain elements may be omitted from some of the views to facilitate understanding of various embodiments of the present invention.

### DESCRIPTION OF THE ILLUSTRATED EMBODIMENTS

Previous homopolar generator designs typically deliver power at high current, but at a voltage that is too low for most commercial applications, typically about three volts or less. Other disadvantages include large size, weight, and cost. The homopolar generators described by Appleton, et al. in U.S. Pat. No. 3,590,295 issued on Jun. 29, 1971 (Appleton) and by McKee in U.S. Pat. No. 4,975,609 issued on Dec. 4, 1990 (McKee), both incorporated herein by reference, describe rotors for homopolar generators that include multiple rotor elements that provide increased voltage output for a given rotor diameter and rotation speed compared to rotors having only a single rotor element.

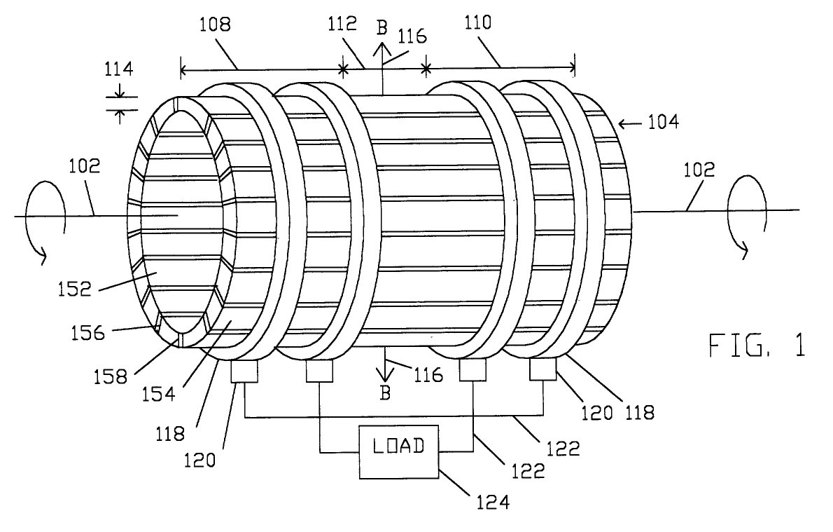

In McKee, the rotor elements (20) in FIG. 1 are coaxially arranged cylinders that generate current continuously through the brush leads (24) for all angles of rotation. As the number of rotor elements (20) is increased, the voltage output also increases. However, the width of the field gap through which the magnetic field extends through the rotor elements (20) is also increased. Disadvantageously, the increased width of the field gap typically results in a reduction of the magnetic field intensity and a corresponding decrease in voltage output.

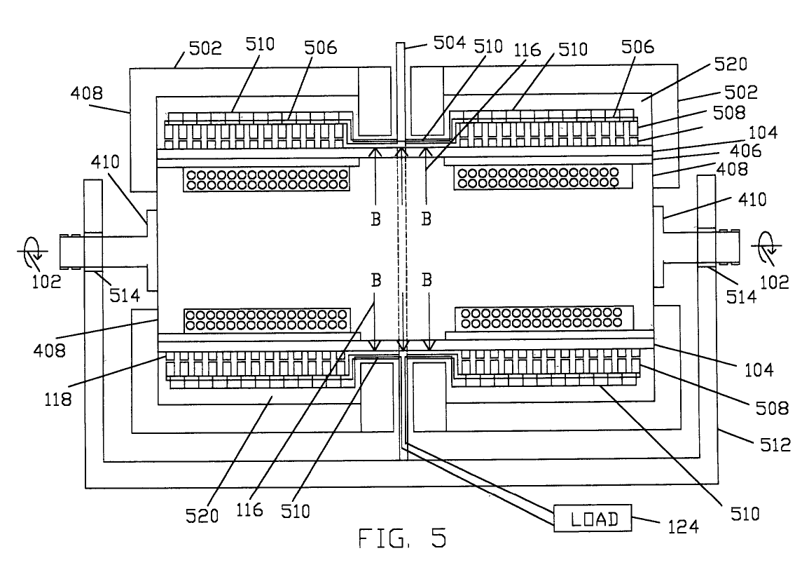

In Appleton, the rotor elements (C) in FIG. 5 are each the same distance from the axis of rotation, so that the width of the field gap through the rotor elements remains constant as the number of rotor elements (C) is increased. Disadvantageously, however, each of the rotor elements (C) is only momentarily in contact with a pair of load brushes (B1) and (B2) as the rotor elements rotate about the axis of rotation, so that electrical current does not flow continuously through each of the rotor elements (C) for all angles of rotation of the rotor elements (C). The interruption of a large current through this type of rotor may cause damage to parts of the generator and may introduce undesirable voltage transients in the generator output.

The homopolar generator of the present invention overcomes the disadvantages in the above examples of the prior art by providing a rotor with multiple rotor elements, each of which is electrically connected to a corresponding pair of brush rings. The brush rings advantageously provide continuous electrical contact through each of the rotor elements for all angles of rotation of the rotor elements about the axis of rotation. Moreover, the number of rotor elements may be multiplied without increasing the field gap width, so that the magnetic field intensity is not reduced by increasing the number of rotor elements. The rotor elements may be advantageously connected in series for generating a voltage output that is suitable for many direct current devices, and the voltage output may also be converted by readily available inverters to various frequencies and voltages to suit a wide variety of applications.

In one embodiment of the present invention, a homopolar generator includes a plurality of rotor elements arranged adjacent to one another on a single circumference of a circle around an axis of rotation for generating an electric current when rotated about the axis of rotation in a magnetic field that extends radially through each of the plurality of rotor elements relative to the axis of rotation. A first brush ring and a second brush ring encircle the axis of rotation and are coupled to at least one of the plurality of rotor elements to conduct the electric current through the at least one of the plurality of rotor elements between the first brush ring and the second brush ring continuously for all angles of rotation of the at least one of the plurality of rotor elements about the axis of rotation.

FIG. 1 illustrates a simplified view of a homopolar generator according to an embodiment of the present invention. Shown in FIG. 1 are an axis of rotation 102, rotor elements 104, a proximal portion 108, a distal portion 110, a middle portion 112, a field gap 114, a magnetic field 116, brush rings 118, load brushes 120, brush leads 122, and an electrical load 124. Each of the rotor elements 104 includes an inner surface 152, an outer surface 154, and two sides 156 and 158.

The rotor elements 104 are arranged adjacent to one another on a single circumference of a circle around the axis of rotation 102. That is to say, the middle portion 112 of each of the rotor elements 104 that extends between the proximal portion 108 and the distal portion 110 inside the field gap 114 is approximately the same distance from the axis of rotation 102, regardless of the number of rotor elements 104. For example, if the middle portion 112 of one of the rotor elements 104 rotates at a distance of 10 centimeters from the axis of rotation 102, then the middle portion 112 of each of the other rotor elements 104 also rotates at a distance of about 10 centimeters from the axis of rotation 102. The limitation of “a single circumference of a circle” is used herein to clearly and unquestionably distinguish the circular arrangement of circumferentially spaced rotor elements 104 illustrated in FIG. 1 from a coaxial arrangement of radially spaced rotor elements such as those disclosed in Mckee. For example, if the number of rotor elements 104 is doubled, the distance from the middle portion 112 of each of the rotor elements 104 to the axis of rotation may also double, but the distance between the axis of rotation 102 and the middle portion 112 of any one of the rotor elements 104 remains about the same as the distance between the axis of rotation 102 and the middle portion 112 of any other one of the rotor elements 104. For the purpose of describing the homopolar generator of the present invention, the condition that the distance between the axis of rotation 102 and the middle portion 112 of any one of the rotor elements 104 be approximately constant is equivalent to stating that the middle portions 112 of the rotor elements 104 are arranged adjacent to one another around a single circumference of a circle about the axis of rotation 102. This feature allows the number of rotor elements 104 to be multiplied without increasing the width of the field gap 114.

The inner surface 152 of each rotor element 104 faces toward the axis of rotation 102 and extends lengthwise along at least the middle portion 112 of the rotor element 104. The outer surface 154 faces away from the axis of rotation 102 and extends lengthwise along at least the middle portion 112 of the rotor element 104. Each of the two opposite sides 156 and 158 of the rotor element 104 terminate both the inner surface 152 and the outer surface 154 lengthwise along at least the middle portion 112 of the rotor element 104. Accordingly, each of the rotor elements 104 is separate from the adjacent rotor elements 104 opposite each of the two sides 156 and 158 along a single circumference of a circle encircling the axis of rotation 102, at least in the region defined by the middle portion 112 between the proximal portion 108 and the distal portion 110. In the example illustrated, each of the rotor elements 104 has an arcuate cross-sectional shape, however, other cross-sectional shapes and configurations for the rotor elements 104 may be used as may become apparent to those skilled in the art to practice the present invention within the scope of the appended claims. For example, each of the rotor elements 104 may include multiple conductors, and each of the multiple conductors may be surrounded by an insulating material. The rotor elements 104 are held in position by the brush rings 118 as further described below.

The field gap 114 extends at least from the inner surface 152 to the outer surface 154 within the middle portion 112 of each of the rotor elements 104. To avoid interfering with the illustration of other elements in FIG. 1, however, the width of the field gap 114 is shown outside the rotor elements 104. The width of the field gap 114 is at least equal to the distance between the inner surface 152 and the outer surface 154 of the rotor elements 104 within the middle portion 112, and may have a greater width to provide clearance between the rotor segments 104 and the brush leads 122. Preferably, the width of the field gap 114 should be kept as small as possible to maximize the strength of the magnetic field 116 through the rotor elements 104. The magnetic field 116 crosses the field gap 114 radially through the middle portion 112 relative to the axis of rotation 102, so that a voltage is developed across the middle portion 112 between the proximal portion 108 and the distal portion 110 of each of the rotor elements 104 when the rotor elements 104 are rotated about the axis of rotation 102. The polarity of the voltage may be reversed by reversing the direction of rotation of the rotor elements 104 about the axis of rotation 102 and also by reversing the direction of the magnetic field 116.

Each of the rotor elements 104 is electrically and mechanically connected to a pair of the brush rings 118. The first brush ring 118 of the pair is connected to the proximal portion 108 of a rotor element 104, and the second brush ring 118 of the pair is connected to the distal portion 110 of the same rotor element 104. In this example, only two pairs of the brush rings 118 are illustrated to simplify the illustration, however, any number of paired brush rings 118 may be selected to practice the present invention within the scope of the appended claims. The greater the number of paired brush rings 118, the higher the available voltage output for a given speed of rotation and strength of the magnetic field 116.

The brush rings 118 are made of an electrically conductive material, such as copper, and have a generally annular shape for maintaining continuous electrical contact between the rotor elements 104 and the load brushes 120 for all angles of rotation of the rotor elements 104 about the axis of rotation 102. More than one of the rotor elements 104 may be electrically connected to each pair of the brush rings 118 to lower the electrical resistance between the brush rings 118. The brush rings 118 conduct an electric current from the rotor elements 104 to the load brushes 120. In the example illustrated, the load brushes 120 are solid electrical conductors made of, for example, carbon. However, other types of load brushes, for example, metal fiber brushes, metal mesh brushes, and liquid brushes that include mercury and electrically conductive lubricants may also be used as may become apparent to those skilled in the art to practice the present invention within the scope of the appended claims. The load brushes 120 are preferably connected in series to sum the voltages of the rotor elements 104, however other configurations of connections among the load brushes 120 may also be used to practice the present invention within the scope of the appended claims, for example, various combinations of parallel and series-parallel connections. For example, more than one voltage output may be obtained from the homopolar generator by connecting separate multiples of the rotor elements 104 through the brushes 118 according to techniques well known in the art to practice the invention within the scope of the appended claims.

A significant feature of the present invention is that the width of the field gap 114 does not have to increase with the number of rotor elements 104. The distance of the rotor elements 104 from the axis of rotation 102 may be increased, that is, the circumference of the circle on which the rotor elements are arranged may be lengthened to accommodate a larger number of rotor elements 104.

Another significant feature of the present invention is that the brush rings 118 provide continuous electrical contact through each of the rotor elements 104 between the corresponding load brushes 120 for all angles of rotation when the rotor elements 104 are rotated about the axis of rotation 102. This feature allows current to flow continuously through each of the rotor elements 104 to the electrical load 124 from the load brushes 120 through the brush leads 122 for all angles of rotation of the rotor elements 104 about the axis of rotation 102. Specifically, each of the rotor elements 104 is in continuous electrical contact with a corresponding pair of load brushes 120 for all angles of rotation of the rotor elements 104 about the axis of rotation 102.

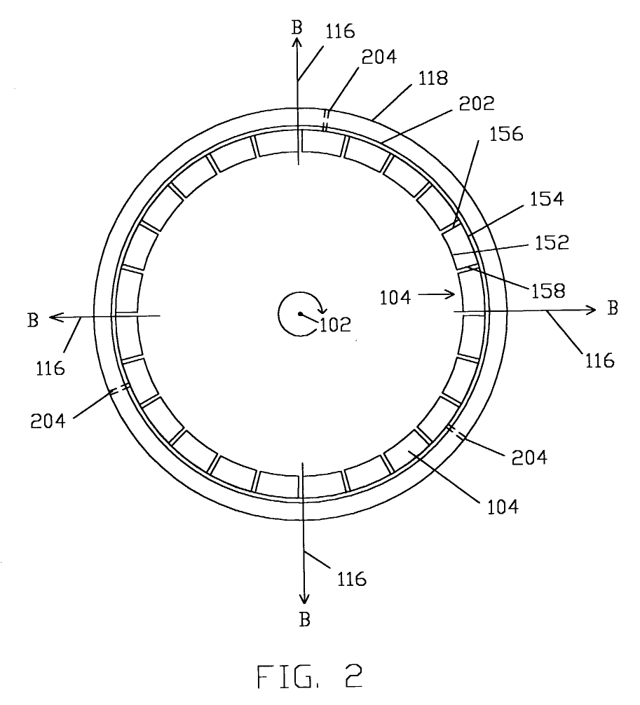

FIG. 2 illustrates a cross-sectional view of a brush ring according to an embodiment of the present invention. Shown in FIG. 2 are rotor elements 104, an inner surface 152 of each rotor element 104, an outer surface 154 of each rotor element 104, two sides 156 and 158 of each rotor element 104, a magnetic field 116, a brush ring 118, an insulating sleeve 202, and brush ring vias 204.

As shown in FIG. 2, the rotor elements 104 are arranged adjacent to one another along a single circumference of a circle around the axis of rotation 102. The brush ring 118 encircles the axis of rotation 102 and lies in a plane that is generally perpendicular to the axis of rotation 102. The insulating sleeve 202 separates the rotor elements 104 from the brush rings 118. The insulating sleeve 202 is not shown in FIG. 1 to simplify the illustration of other aspects of the invention.

The insulating sleeve 202 electrically insulates each of the brush rings 118 from the rotor elements 104 while providing mechanical support for fastening the brush rings 118 to the rotor elements 104. The insulating sleeve 202 may be, for example, a single cylindrically shaped piece made of an electrically insulating material such as teflon appropriately dimensioned to fit between the rotor elements 104 and the brush rings 118. Alternatively, the insulating sleeve 202 may include multiple segments, for example, two cylindrically shaped pieces, extending between the rotor elements 104 and the brush rings 118 and leaving the middle portion 112 of the rotor elements 104 uncovered by the insulating sleeve 202. Alternatively, the insulating sleeve 202 may be an insulated tape winding or other type of insulator having any suitable shape as may become apparent to those skilled in the art to practice the present invention within the scope of the appended claims. The insulating sleeve 202 may also be reinforced by a tape winding or other type of reinforcing material to increase the mechanical stability of the rotor elements 104. Also, the insulating sleeve 202 may be implemented by insulation surrounding each of the rotor elements 104, and the insulation may be removed between each of the rotor elements 104 and the corresponding brush rings 118 to expose the inside conductor of each of the rotor elements 104. Electrical connection between each of the rotor elements 104 and the corresponding brush rings 118 may then be made according to well known techniques. The connections between the rotor elements 104 and the brush rings 118 are depicted generally as the brush ring vias 204.

The brush ring vias 204 make electrical connection from each of the brush rings 118 through the insulating sleeve 202 to one or more of the rotor elements 104. For example, the brush ring vias 204 may be made by drilling a hole from the outside of a brush ring 118 through the insulating sleeve 202 to a rotor element 104. The hole may also be extended partially or completely through the rotor element 104. The hole may be filled with solder, silver solder, or other electrically conductive bonding material. Alternatively, a cylindrical solid conductor may be inserted in the hole through the brush ring 118 and the insulating sleeve 202 to or through the rotor element 104. Further, the hole may be tapped through at least a portion of the brush ring 118 to receive a threaded insert. The solid conductor or the threaded insert may be inserted in the hole and soldered to the brush ring 118. Any protruding material may be ground or machined flush to the surface of the brush ring 118. The brush ring vias 204 may also be implemented by other devices for making electrical contact between the rotor elements 104 and the brush rings 118 as may become apparent to those skilled in the art to practice the present invention within the scope of the appended claims.

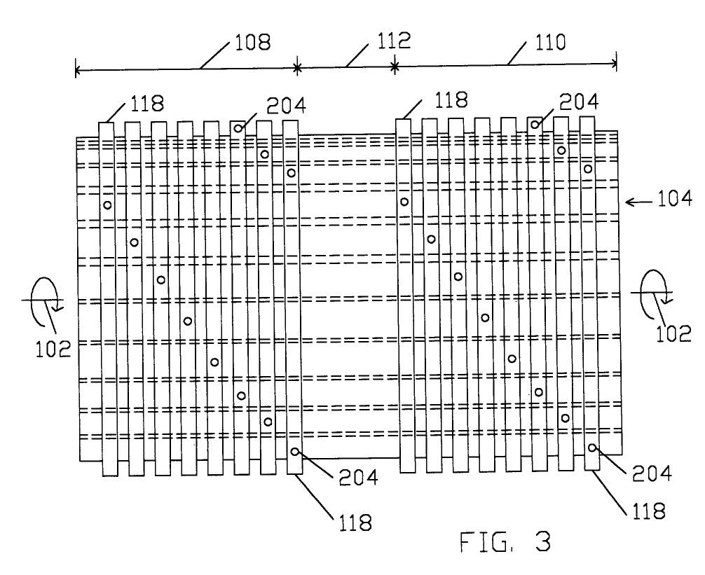

In the example illustrated in FIG. 2, each of the brush rings 118 is connected by the brush ring vias 204 to three rotor elements 104 at intervals of 120 degrees around the axis of rotation 102 for increased mechanical stability and lowered electrical resistance between the brush rings 118 and the rotor elements 104. Alternatively, each of the brush rings 118 may be connected to one or more rotor elements 104 at various angles around the axis of rotation 102 to suit specific applications within the scope of the appended claims. In the example of FIG. 2, there are 24 rotor elements, and each brush ring 118 is electrically connected to three of the rotor elements 104 by the brush ring vias 204. Accordingly, there are eight brush rings 118 around the proximal portion 108 and eight brush rings 118 around the distal portion 110 of the rotor elements 104. Each of the brush rings 118 is connected to three of the rotor elements 104. Any ordering scheme for connecting the brush rings 118 to the rotor elements 104 by the brush ring vias 204 may be used to practice the invention within the scope of the appended claims, one of which is illustrated in FIG. 3.

FIG. 3 illustrates a front view of the embodiment illustrated in FIG. 2. Shown in FIG. 3 are an axis of rotation 102, rotor elements 104, a proximal portion 108 of the rotor elements 104, a distal portion 110 of the rotor elements 104, a middle portion 112 of the rotor elements 104, brush rings 118, and brush ring vias 204.

In this example, each brush ring 118 in the proximal portion 108 of the rotor elements 104 is connected by the brush ring vias 204 to three rotor elements 104 immediately adjacent to the three rotor elements 104 connected to the adjacent brush ring 118. The same order of connection is repeated in the distal end 110 of the rotor elements 104. In this arrangement, the length and corresponding electrical resistance of the rotor elements 104 between each pair of the brush rings 118 remains approximately the same. Other arrangements for connecting the brush rings 118 to the rotor elements 104 may be used as may become apparent to those skilled in the art to practice the present invention within the scope of the appended claims. For example, the order of connection may be reversed on the proximal end 108 or the distal end 110 so that the innermost pair of brush rings 118 is connected to one or more rotor elements 104, the next innermost pair of brush rings 118 is connected to another one or more rotor elements 104, and so on. Unless expressly limited otherwise, all orders of connection of the brush rings 118 to the rotor elements 104 are encompassed within the scope of the appended claims.

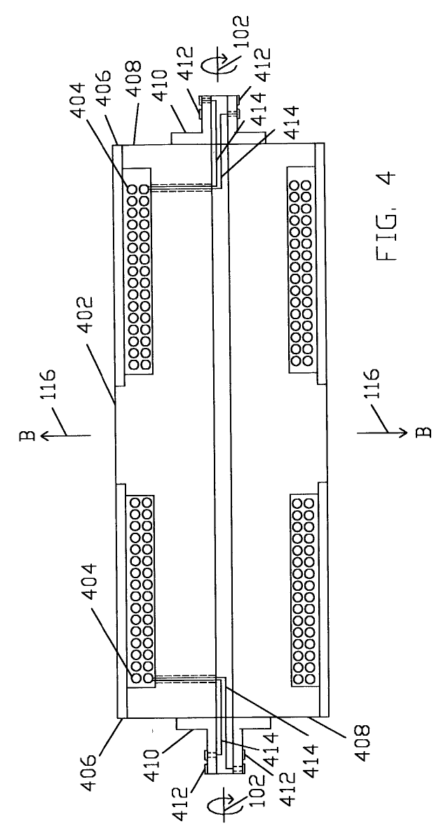

FIG. 4 illustrates a cross-sectional view of a source of a magnetic field for the homopolar generator of FIG. 1 according to an embodiment of the present invention. Shown in FIG. 4 are an axis of rotation 102, a magnetic field 116, a flux core 402, field windings 404, a support sleeve 406, support collars 408, shaft ends 410, slip rings 412, and field leads 414.

The flux core 402 preferably has a cylindrical shape for rotating about the axis of rotation 102 and is preferably made of a highly magnetically permeable material, such as soft iron. The flux core 402 is dimensioned to support the rotor elements 104 so that the center of the flux core 402 is approximately aligned with the middle portion 112 of the rotor elements 104 along the axis of rotation 102. The field windings 404 at opposite ends of the flux core 402 may be made according to well known techniques for generating a magnetic field and may include, for example, copper wire or a superconductor. The ends of the field windings 404 are connected to the field leads 414. The field leads 414 may be insulated copper wires or other suitable electrical conductors and may be routed, for example, through radial holes through the flux core 402 into a hollow center of the flux core 402 and out through radial holes in the shaft ends 410 to the slip rings 412. Electrical contact with the slip rings 412 may be made by slip ring brushes (not shown) according to well known techniques. An electrical power source (not shown) may be connected to the slip ring brushes to generate an electric current in the field windings 404 so that like poles of the magnetic fields of the field windings 404 are facing each other to generate the magnetic field 116 that extends radially relative to the axis of rotation 102. The magnetic field 116 may extend either radially away from or radially toward the axis of rotation 102. In the example illustrated, the magnetic field 116 extends radially away from the axis of rotation 102.

In place of or in addition to the field windings 404, permanent magnets may be arranged or formed in the flux core 402. For example, the flux core 402 may be made at least partially of a sintered neodymium-iron-boron compound, and the portions of the flux core 402 that extend inside the proximal portion 108 and the distal portion 110 of the rotor elements 104 may each be formed into permanent magnets by magnetizing the portions of the flux core 402 along the axis of rotation 102 according to well known techniques to produce the magnetic field 116 that extends radially from the flux core 402 relative to the axis of rotation 102. Also, one or more permanent magnets may be arranged or formed in the center portion of the flux core 402 to generate the magnetic field 116.

The support sleeve 406 covers the field windings 404 wound on the flux core 402. The support sleeve 406 preferably has a cylindrical shape and is dimensioned to fit over the flux core 402 and to support the rotor elements 104 on the circumference of the flux core 402. The support sleeve 406 is preferably made of a relatively non-magnetic material such as brass, copper, aluminum, teflon, or the like. However, at least a portion of the support sleeve 406 may include a magnetic material such as iron to suit specific applications within the scope of the appended claims. Also, the support sleeve 406 may include more than one piece. In FIG. 4, for example, the support sleeve 406 includes two pieces, so that the center of the flux core 402 may extend closer to the middle portion 112 of the rotor elements 104, thereby avoiding adding the thickness of the support sleeve 406 to the width of the field gap 114 along the middle portion 112 of the rotor elements 104. Also, the support sleeve 406 may include grooves (not shown) to align the rotor elements 104 with respect to the axis of rotation 102. The rotor elements 104 may be fastened, for example, by electrically insulated bolts or by other suitable fastening devices to the support sleeve 406 and to the flux core 402. By way of example, the ends of the proximal portion 108 and the distal portion 110 of the rotor elements 104 may be fastened through the support sleeve 406 to the support collars 408 by teflon shoulder washers and brass screws.

The support collars 408 are widened portions at each end of the flux core 402 that are dimensioned to fit against the inside wall of the support sleeve 406.

The shaft ends 410 are preferably made of a non-magnetic material such as brass, copper, aluminum, or the like, although at least a portion of the shaft ends 410 may include a magnetic material such as iron to suit specific applications within the scope of the appended claims. The shaft ends 410 may be fastened at the widened end by bolts or by other well known fastening devices to the support collars 408 and journaled at the other end into bearings mounted on a frame (not shown) according to well known mechanical techniques so that the flux core 402 and the rotor elements 104 may be rotated about the axis of rotation 102 to generate the desired voltage output at the electrical load 124. The slip rings 412 may be conveniently located, for example, on the shaft ends 410. In one embodiment, the slip rings 412 are electrically insulated from the shaft ends 410 and fastened to the shaft ends 410 according to well known techniques to avoid interfering with the bearings and the frame or other mechanical supports to practice the present invention within the scope of the appended claims.

The source of the magnetic field 116 illustrated in FIG. 4 rotates with the rotor elements 104. In addition to the embodiment illustrated in FIG. 4, other sources of the magnetic field 116 may also be used to generate the magnetic field 116 according to well known techniques to practice the present invention within the scope of the appended claims. For example, the source of the magnetic field 116 may include conventional stator arrangements that do not rotate with the rotor elements 104. An example of a conventional stator arrangement that may be used to generate the magnetic field 116 is described in McKee.

FIG. 5 illustrates a cross-sectional view of a homopolar generator according to an embodiment of the present invention including a flux return. Shown in FIG. 5 are an axis of rotation 102, rotor elements 104, brush rings 118, an electrical load 124, a support sleeve 406, support collars 408, shaft ends 410, flux returns 502, a brush lead support 504, load brush supports 506, load brushes 508, brush leads 510, a frame 512, shaft bearings 514, and a clearance space 520.

The flux returns 502 return the magnetic field 116 outside the rotor elements 104 from the inner surface 152 of the rotor elements 104 around the ends to the outer surface 154 of the rotor elements 104 (the inner surface 152 and the outer surface 154 of the rotor elements 104 are illustrated in FIG. 1). The flux returns 502 preferably have a generally cylindrical shape to facilitate rotation about the axis of rotation 102 and are preferably made of a highly magnetically permeable material, for example, soft iron, to return the magnetic field 116 to the field gap 114. In other embodiments of the present invention, the flux returns 502 may be permanently or electrically magnetized to assist in the formation of the magnetic field 116 within the scope of the appended claims.

The flux returns 502 may each include multiple segments to facilitate assembly around the rotor elements 104, the brush supports 506, and the brush leads 510. The multiple segments of the flux returns 502 may be assembled and fastened according to well known techniques. In one embodiment, each flux return 502 includes two segments, an inner segment and an outer segment. The inner segment of each of the flux returns 502 has a generally annular shape, and the outer segment has a generally cylindrical shape with a flange for mounting the flux returns 502 on the support collars 408 by bolts or by other well known fastening techniques.

The brush lead support 504 extends around the rotor elements 104 and between the flux returns 502 to provide mechanical support for the load brush supports 506, the load brushes 508, and the brush leads 510. The brush lead support 504 may be implemented, for example, by a rigid plate having a circular opening sufficient to allow the rotor elements 104 to rotate freely inside the brush lead support 504 and a thickness sufficient to support the load brush supports 506, the load brushes 508, and the brush leads 510. The brush lead support 504 is preferably made of a non-magnetic material, for example, brass, copper, or aluminum. However, at least a portion of the brush lead support 504 may be made of a magnetic material such as soft iron to suit specific applications within the scope of the appended claims. The brush lead support 504 may be fastened according to well known mechanical techniques to the frame 512 that supports the shaft ends 410 on the bearings 514. The brush leads 510 are routed through the brush lead support 504 between the load brushes 508 to connect the rotor elements 104, for example, in series. Two or more of the brush leads 510, typically the two ends of a series connection, may be routed along the brush lead support 504 out to the frame 512 for connection to the electrical load 124. The electrical load 124 may be any device connected to the brush leads 510, for example, lighting equipment, an inverter for converting DC to AC, a DC voltage level converter, a motor, welding equipment, and electrical power tools.

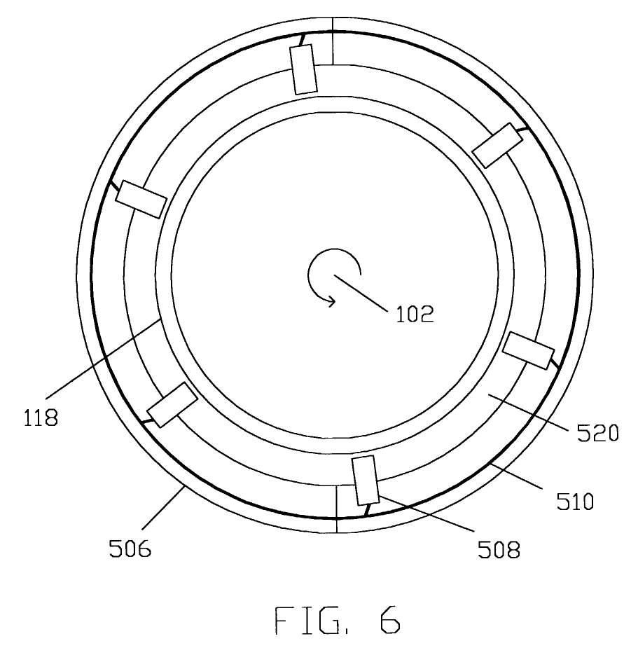

The load brush supports 506 extend from the brush lead support 504 in the clearance space 520 between the rotor elements 104 and the flux returns 502 so that the rotor elements 104 can rotate inside the load brush supports 506, and so that the flux returns 502 can rotate outside the load brush supports 506. To simplify the illustration, the load brushes 508 are shown slightly separated from the brush rings 118. In operation, however, the load brush supports 506 hold the load brushes 508 in sliding electrical contact against the brush rings 118. The load brush supports 506 also guide the brush leads 510 from the load brushes 508 to the brush lead support 504. Electrical sliding contact may be made to each brush ring 118 by a single load brush 508 or by multiple load brushes 508. The load brush supports 506 may include linear arrays of load brushes 508, an example of which is illustrated in FIG. 5, or the load brush supports 506 may include circular arrays of load brushes 508, an example of which is illustrated in FIG. 6.

FIG. 6 is a side view of an annular part of a load brush support 506. Shown in FIG. 6 are an axis of rotation 102, a brush ring 118, load brushes 508, a brush lead 510, and a clearance space 520.

The annular part of the load brush support 506 in this example has a generally annular shape to fit around one of the brush rings 118 within the clearance space 520 between the brush ring 118 and the flux return 502 shown in FIG. 5. In one embodiment, each of the brush rings 118 is surrounded by an identical annular part of the load brush support 506. Each annular part of the load brush support 506 may include multiple segments to facilitate assembly of the load brush support 506 around each of the rotor elements 104. One or more of the load brushes 508 are fastened around the annular part of the load brush support 506 to make sliding electrical contact with the brush ring 118. The load brushes 508 may include springs or other devices (not shown) to control the pressure of the load brushes 508 against the brush ring 118. The brush lead 510 connects the load brushes 508, for example, in parallel around the brush ring 118 to lower the brush resistance and to evenly distribute the current flow in the brush ring 118. The brush lead 510 also extends along the lengthwise portion of the brush support 506 as shown in FIG. 5 to connect to another brush ring 118 or to the electrical load 124. The circular arrangement of the load brushes 508 around the brush rings 118 also increases the mechanical stability of the load brush support 506 during rotation of the rotor elements 104 about the axis of rotation 102 by distributing displacement forces in the load brush support 506 around the brush rings 118.

While the invention herein disclosed has been described with reference to representative embodiments having specific features, persons skilled in the art will recognize that other modifications, variations, and arrangements of the present invention may be made in accordance with the above teachings other than as specifically described to practice the invention within the spirit and scope defined by the following claims.

What is claimed is:

1. A homopolar generator comprising:
a plurality of rotor elements arranged adjacent to one another on a single circumference of a circle around an axis of rotation for generating an electric current in at least one of the plurality of rotor elements when the plurality of rotor elements is rotated about the axis of rotation in a magnetic field that extends radially through the plurality of rotor elements relative to the axis of rotation;
a first brush ring encircling the axis of rotation and coupled to the at least one of the plurality of rotor elements; and
a second brush ring encircling the axis of rotation and coupled to the at least one of the plurality of rotor elements wherein the second brush ring maintains continuous electrical contact with the first brush ring through the at least one of the plurality of rotor elements for all angles of rotation of the at least one of the plurality of rotor elements about the axis of rotation.

2. The homopolar generator of claim 1 wherein the at least one of the plurality of rotor elements comprises:
an inner surface that extends lengthwise along the at least one of the plurality of rotor elements and faces the axis of rotation;
an outer surface that extends lengthwise along the at least one of the plurality of rotor elements and faces away from the axis of rotation;
a first side that terminates the inner surface and the outer surface lengthwise along the at least one of the plurality of rotor elements; and
a second side opposite the first side that terminates the inner surface and the outer surface lengthwise along the at least one of the plurality of rotor elements.

3. The homopolar generator of claim 1 further comprising a first load brush coupled to make sliding electrical contact with the first brush ring and a second load brush coupled to make sliding electrical contact with the second brush ring for coupling the electric current to an electrical load.

4. The homopolar generator of claim 3 further comprising the electrical load.

5. The homopolar generator of claim 1 further comprising a source of the magnetic field coupled to the plurality of rotor elements.

6. The homopolar generator of claim 5 wherein the source of the magnetic field comprises at least one of a permanent magnet and an electromagnet.

7. The homopolar generator of claim 5 wherein the source of the magnetic field is coupled to rotate with the plurality of rotor elements about the axis of rotation.

8. The homopolar generator of claim 5 further comprising a flux return coupled to the source of the magnetic field for returning the magnetic field outside the at least one of the plurality of rotor elements from the inner surface to the outer surface of the at least one of the plurality of rotor elements.

9. A homopolar generator comprising:
a plurality of rotor elements arranged adjacent to one another on a single circumference of a circle around an axis of rotation for generating a voltage across a middle portion of at least one of the plurality of rotor elements between a proximal portion and a distal portion of the at least one of the plurality of rotor elements when the plurality of rotor elements is rotated about the axis of rotation in a magnetic field that extends radially through the plurality of rotor elements relative to the axis of rotation wherein the middle portion of the at least one of the plurality of rotor elements comprises:
an inner surface that extends lengthwise along the middle portion and faces the axis of rotation;
an outer surface that extends lengthwise along the middle portion and faces away from the axis of rotation;
a first side that terminates the inner surface and the outer surface lengthwise along the at least one of the plurality of rotor elements; and
a second side opposite the first side that terminates the inner surface and the outer surface lengthwise along the at least one of the plurality of rotor elements;
a first brush ring encircling the axis of rotation and coupled to the proximal portion of the at least one of the plurality of rotor elements; and
a second brush ring encircling the axis of rotation and coupled to the distal portion of the at least one of the plurality of rotor elements wherein the second brush ring maintains continuous electrical contact with the first brush ring through the middle portion of the at least one of the plurality of rotor elements for all angles of rotation of the at least one of the plurality of rotor elements about the axis of rotation.

10. The homopolar generator of claim 9 further comprising a first load brush coupled to make sliding electrical contact with the first brush ring and a second load brush coupled to make sliding electrical contact with the second brush ring for coupling the voltage to an electrical load.

11. The homopolar generator of claim 10 further comprising the electrical load.

12. The homopolar generator of claim 9 further comprising a source of the magnetic field coupled to the plurality of rotor elements.

13. The homopolar generator of claim 12 wherein the source of the magnetic field is coupled to rotate with the plurality of rotor elements about the axis of rotation.

14. The homopolar generator of claim 12 further comprising a flux return coupled to the source of the magnetic field for returning the magnetic field outside the at least one of the plurality of rotor elements from the inner surface to the outer surface of the at least one of the plurality of rotor elements.

15. A homopolar generator comprising:
a plurality of rotor elements arranged adjacent to one another on a single circumference of a circle around an axis of rotation to generate an electric current through at least one of the plurality of rotor elements when the plurality of rotor elements is rotated about the axis of rotation in a magnetic field that extends radially through the plurality of rotor elements relative to the axis of rotation;
a first brush ring encircling the axis of rotation and coupled to the at least one of the plurality of rotor elements; and
a second brush ring encircling the axis of rotation and coupled to the at least one of the plurality of rotor elements wherein the second brush ring maintains continuous electrical contact with the first brush ring through the at least one of the plurality of rotor elements for all angles of rotation of the at least one of the plurality of rotor elements about the axis of rotation wherein the at least one of the plurality of rotor elements comprises:
an inner surface that extends lengthwise along the at least one of the plurality of rotor elements and faces the axis of rotation;
an outer surface that extends lengthwise along the at least one of the plurality of rotor elements and faces away from the axis of rotation;
a first side that terminates the inner surface and the outer surface lengthwise along the at least one of the plurality of rotor elements; and
a second side opposite the first side that terminates the inner surface and the outer surface lengthwise along the at least one of the plurality of rotor elements.

16. The homopolar generator of claim 15 further comprising a first load brush coupled to make sliding electrical contact with the first brush ring and a second load brush coupled to make sliding electrical contact with the second brush ring for coupling the electric current to an electrical load.

17. The homopolar generator of claim 16 further comprising a source of the magnetic field coupled to the plurality of rotor elements.

18. The homopolar generator of claim 17 wherein the source of the magnetic field is coupled to rotate with the plurality of rotor elements about the axis of rotation.

19. The homopolar generator of claim 17 further comprising a flux return coupled to the source of the magnetic field for returning the magnetic field outside the at least one of the plurality of rotor elements from the inner surface to the outer surface of the at least one of the plurality of rotor elements.

20. The homopolar generator of claim 19 further comprising a load brush support extending between the flux return and the plurality of rotor elements to support the first load brush and the second load brush.
